(19) United States
(12) Patent Application Publication
(10) Pub. No.: US 2012/0276835 A1
(43) Pub. Date: Nov. 1, 2012

(54) ISOLATION BOOTH

(76) Inventor: Yoshihito FUKUDA, Toyota-shi (JP)

(21) Appl. No.: 13/452,982

(22) Filed: Apr. 23, 2012

(30) Foreign Application Priority Data
Apr. 26, 2011 (JP) 2011-098763

(51) Int. Cl. B01L 1/04

(52) U.S. Cl. 454/187

(57) ABSTRACT

An isolation booth for creating a locally isolated space, includes: a top portion; a bottom portion; a curtain rail that is provided on at least one of the top portion and the bottom portion; and a curtain member that is in an endless belt shape and has a ring shape when viewed from above, is supported by the curtain rail in a manner so as to be able to be moved along the curtain rail, and is provided so as to create the space between the top portion and the bottom portion, the curtain member including a glove member that bulges out toward an inside of the space.

### INCORPORATION BY REFERENCE

The disclosure of Japanese Patent Application No. 2011-098763 filed on Apr. 26, 2011 including the specification, drawings and abstract is incorporated herein by reference in its entirety.

### BACKGROUND OF THE INVENTION

1. Field of the Invention

The invention relates to an isolation booth that is an apparatus for isolating an area and maintaining that area at an environment different from the outside of the area.

2. Description of Related Art

In manufacturing a product, it is necessary to adjust the environment around the manufacturing equipment according to manufacturing conditions. The term “environment” here includes various conditions such as temperature and relative humidity conditions, the degree of cleanliness, the property of atmospheric gas, etc.

For example, when it is necessary to operate manufacturing equipment in an extremely clean environment, enormous initial and running costs are incurred in an effort to make the entire process using the manufacturing equipment “clean.”

Therefore, in such a case, an isolation booth (what is called “clean booth”) that enables the degree of cleanliness to be increased only around the manufacturing equipment by isolating the area around the manufacturing equipment with a localized curtain-shaped member, is widely used. Using a clean booth makes it possible to reduce the initial and running costs as compared to those incurred when the entire process using the manufacturing equipment is made “clean.”

Isolation booths for various uses are available. In addition to clean booths for creating extremely clean localized environments, isolation booths for creating environments with different localized temperature and relative humidity conditions (such as dry rooms), and isolation booths for preventing organic solvents etc. in the atmosphere from being dispersed around, are available. For example, a simple clean booth is described in Japanese Patent Application Publication No. 5-231686 (JP 5-231686 A).

However, with this kind of isolation booth, in order for a worker to get near the manufacturing equipment that is in the isolation booth, the worker must change into predetermined clean room wear, or pass through an air shower to remove any adhered dust and the like. Therefore, daily operation, maintenance, and the like performed near the manufacturing equipment are cumbersome.

Therefore, to reduce the amount of trouble of work performed near the manufacturing equipment, various technologies for performing automated conveyance and the like are being considered. Japanese Patent Application Publication No. 9-133385 (JP 9-133385 A) and Japanese Patent Application Publication No. 2003-309162 (JP 2003-309162 A), for example, describe such technologies. With the related art described in JP 9-133385 A and JP 2003-309162 A, a product that comes out of the manufacturing equipment is conveyed by an automated conveying trolley, so a worker does not need to get close to the manufacturing equipment to collect the product, thereby enabling the trouble of daily operations to be reduced.

However, even if an automated conveying trolley is used as in the related art described in JP 9-133385 A and JP 2003-309162 A, a worker still must change into clean room wear and pass through an air shower and get close to the manufacturing equipment when carrying out maintenance on the manufacturing equipment, so the maintenance work remains cumbersome. Moreover, the body, the exhalation, etc. of a worker emit foreign particles, humidity, and the like. Further, when the isolated area is a solvent environment, for example, a worker must put on a mask or the like before entering the isolated area. Therefore, there is a need for technology that enables a worker to get close to the manufacturing equipment without entering the isolated area, when using an isolation booth.

### SUMMARY OF THE INVENTION

The invention thus provides an isolation booth that enables a worker to easily get close to manufacturing equipment, and operate and perform maintenance and the like on the manufacturing equipment, without entering an isolated area.

A first aspect of the invention is an isolation booth for creating a locally isolated space, including: a top portion; a bottom portion; a curtain rail that is provided on at least one of the top portion and the bottom portion; and a curtain member that is in an endless belt shape and has a ring shape when viewed from above, is supported by the curtain rail in a manner so as to be able to be moved along the curtain rail, and is provided so as to create the space between the top portion and the bottom portion, the curtain member including a glove member that bulges out toward an inside of the space.

A second aspect of the invention is an isolation booth for creating a locally isolated space, including a curtain member for isolating the locally isolated space, the curtain member being formed in an endless belt shape and has a ring shape when viewed from above, wherein: the curtain member includes a glove member that bulges out toward an inside of the locally isolated space; the curtain member is supported by a curtain rail that has a ring shape when viewed from above; and the curtain member and the glove member are configured to be able to be moved along the curtain rail.

According to these aspects of the invention, it is possible to move the glove member along the curtain rail. As a result, each portion of manufacturing equipment inside the isolation booth can be operated from various angles.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1A is a front view showing a schematic diagram of an overall structure of an isolation booth according to a first example embodiment of the invention;

FIG. 1B is a side view showing a schematic diagram of the overall structure of the isolation booth according to the first example embodiment of the invention;

FIG. 2A is a perspective view showing a schematic diagram of the overall structure of the isolation booth according to the first example embodiment of the invention;

FIG. 2B is a schematic diagram of the isolation booth according to the first example embodiment of the invention, showing a state, in which a glove member is attached;

FIG. 3A is a view on arrow X in FIG. 1A, showing a schematic diagram of an upper curtain rail provided in the isolation booth;

FIG. 3B is a view on arrow Y in FIG. 1A, showing a schematic diagram of a lower curtain rail provided in the isolation booth;

FIG. 4A is a side sectional view showing a schematic diagram of a state in which a curtain member is supported by the curtain rail;

FIG. 4B is a front sectional view showing a schematic diagram of a state in which the curtain member is supported by the curtain rail;

FIG. 5A is a front view showing a schematic diagram of an overall structure of an isolation booth according to a second example embodiment of the invention;

FIG. 5B is a side sectional view showing a schematic diagram of the overall structure of the isolation booth according to the second example embodiment of the invention;

FIG. 6 is a schematic perspective view showing the isolation booth according to the second example embodiment of the invention;

FIG. 7 is a schematic sectional view showing an upper curtain box attached to the upper curtain rail; and

FIG. 8 is a schematic sectional view showing a lower curtain box attached to the lower curtain rail.

### DETAILED DESCRIPTION OF EMBODIMENTS

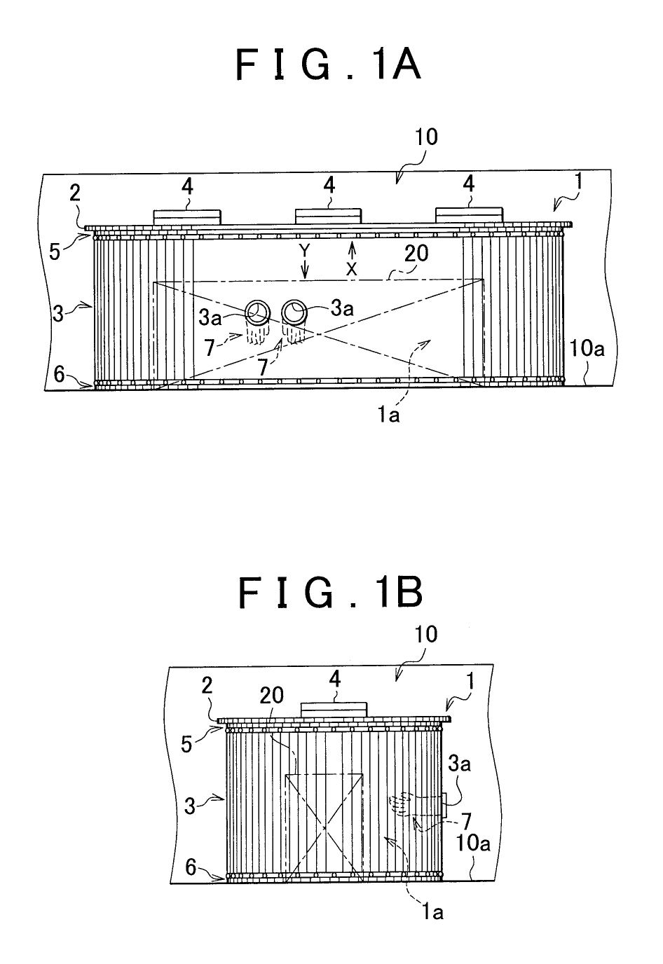

Next, example embodiments of the invention will be described. First, an overall structure of an isolation booth according to a first example embodiment of the invention will be described with reference to FIGS. 1A to 4B. In this description, the direction of arrow X in FIGS. 1A and 1B indicates the upper side of the isolation booth, and the direction of arrow Y indicates the lower side of the isolation booth. Also in the description, the direction orthogonal to arrows X and Y will be referred to as the lateral direction.

An isolation booth 1 that is the isolation booth according to the first example embodiment of the invention shown in FIGS. 1A and 1B is an apparatus (what is called “clean booth”) for increasing the degree of cleanliness of the space inside of it (hereinafter referred to as the “booth interior 1a”) as compared to the degree of cleanliness outside of the space. In this example embodiment, the isolation booth 1 is arranged so as to surround manufacturing equipment 20 that is arranged in a processing room 10. The isolation booth 1 creates a space (i.e., the booth interior 1a) around the manufacturing equipment 20 where a higher degree of cleanliness than that of the processing room 10 is secured.

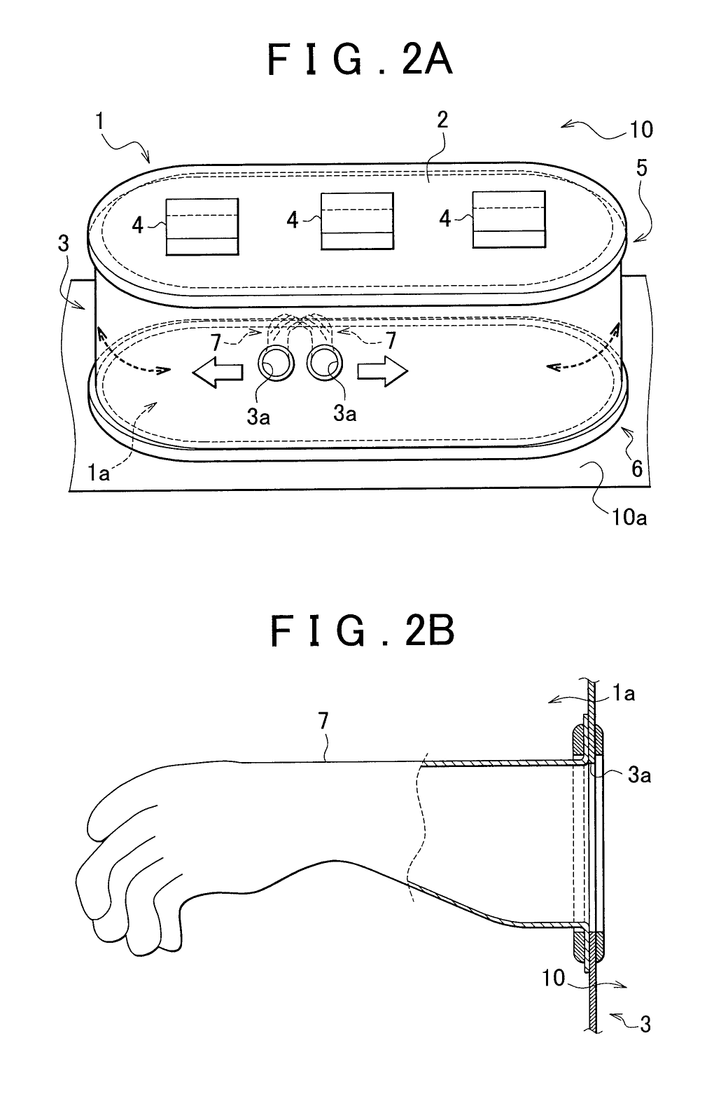

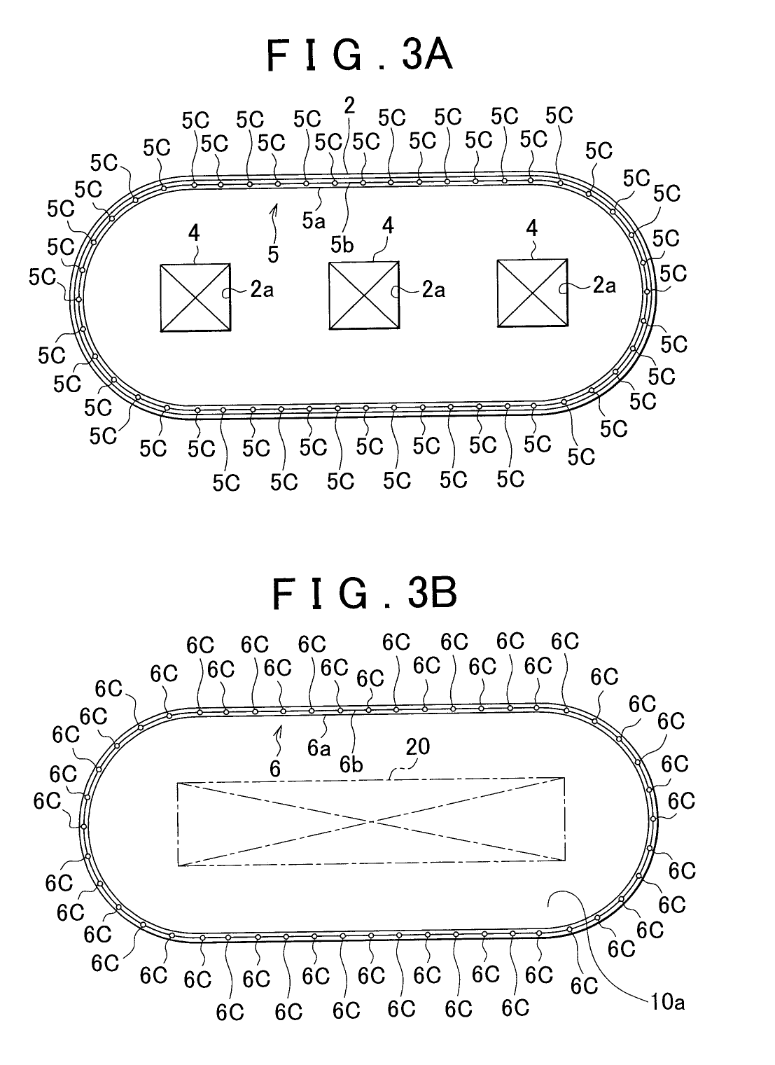

As shown in FIGS. 2A and 3A, the isolation booth 1 is structured such that the upper surface (i.e., a ceiling surface) is covered in an airtight manner by a top panel 2 that is generally oval-shaped when viewed from above. Also a lower surface (i.e., a floor surface) of the isolation booth 1 is formed by a floor 10a of the processing room 10, as shown in FIGS. 2A and 3B. The top panel 2 is supported by a support frame and the like, not shown, that stands on the floor 10a. Note that the ceiling of the installation space for the booth may be used as the top portion of the invention and in this case, the ceiling functions as the top portion of the invention. In addition, although the bottom portion of the invention may be a separate member, the floor of the installation space for the booth may be used as the bottom portion and, in this embodiment, the floor 10a functions as the bottom portion of the invention.

Also, as shown in FIG. 3A, an upper curtain rail 5 that has a generally oval ring shape when viewed from above is provided on a lower surface of a peripheral portion of the top panel 2. Also, as shown in FIG. 3B, a lower curtain rail 6 having the same shape as the upper curtain rail 5 (i.e., that has a generally oval ring shape when viewed from above) is provided on the floor 10a. These curtain rails 5 and 6 are arranged parallel when viewed from the side and arranged at positions such that the curtain rails 5 and 6 coincide with each other when viewed from above (see FIG. 2A).

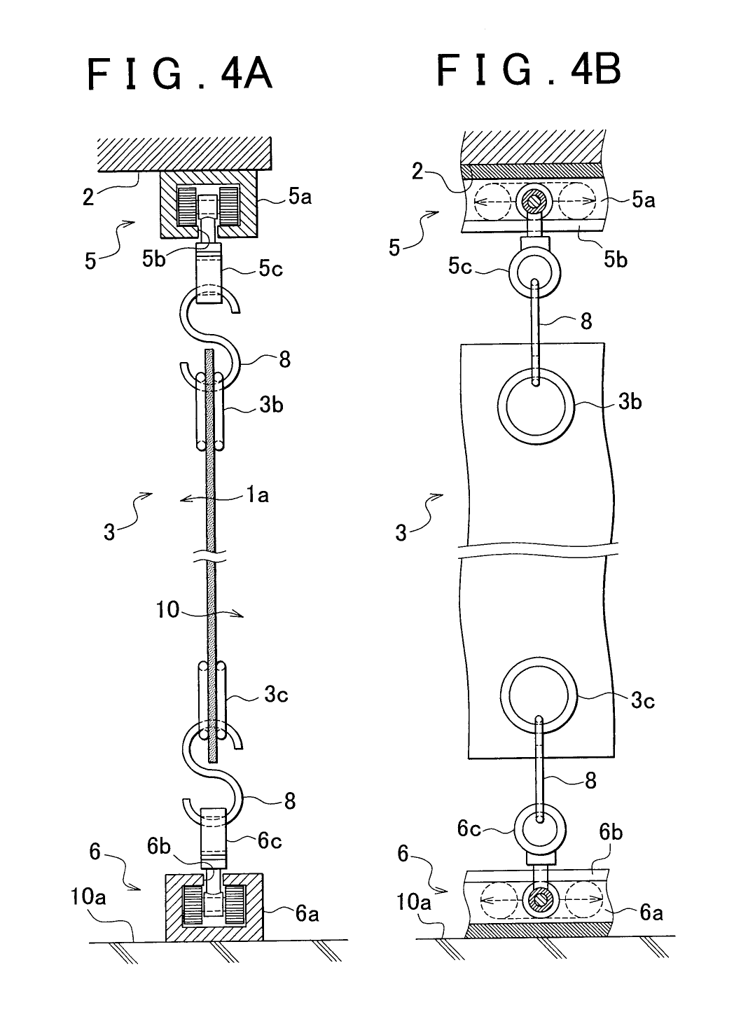

Also, in the isolation booth 1, a curtain member 3 is formed extending between the curtain rails 5 and 6, and a vertical surface (i.e., a side surface) between the top panel 2 and the floor 10a is covered in an airtight manner by the curtain member 3, as shown in FIGS. 4A and 4B. The size and shape of the isolation booth 1 may be changed as appropriate according to the sizes, the shapes, etc. of the manufacturing equipment 20 that is to be arranged inside the isolation booth 1, the processing room 10, and the like.

The attachment of the curtain member 3 will now be described. The curtain member 3 is formed by a flexible transparent resin sheet, for example, and has a substantially endless belt shape, as shown in FIG. 2A.

As shown in FIGS. 4A and 4B, the upper curtain rail 5 provided on the lower surface of the top panel 2 includes a rail member 5a, and a plurality of runner members 5c are inserted into a groove portion 5b formed in the rail member 5a. These runner members 5c are configured to be able to slide along the groove portion 5b in the direction in which the rail member 5a extends.

As shown in FIG. 3A, the upper curtain rail 5 is such that the rail member 5a forms a ring (i.e., is endless) when viewed from above, and the plurality of runner members 5c are arranged in a generally ring shape at intervals along the groove portion 5b of the rail member 5a.

Further, as shown in FIGS. 4A and 4B, the lower curtain rail 6 includes a rail member 6a, and a plurality of runner members 6c are inserted into a groove portion 6b formed in the rail member 6a. These runner members 6c are configured to be able to slide along the groove portion 6b in the direction in which the rail member 6a extends.

Also, as shown in FIG. 3B, the lower curtain rail 6 is such that the rail member 6a forms a ring (i.e., is endless) when viewed from above, and the plurality of runner members 6c are arranged in a generally ring shape at intervals along the groove portion 6b of the rail member 6a.

Also, as shown in FIG. 2A, the curtain member 3 is generally cylindrical with open ends in the vertical direction, and has a plurality of hook retaining portions (eyelets) 3b that are portions for retaining S-hooks 8 at substantially equidistant intervals in the circumferential direction at the upper open end portion, and a plurality of hook retaining portions 3c that are portions for retaining S-hooks 8 at substantially equidistant intervals in the circumferential direction at the lower open end portion.

Also, the curtain member 3 is extended between the upper curtain rail 5 and the lower curtain rail 6 by fastening the hook retaining portions 3b of the upper portion to the runner members 5c of the upper curtain rail 5 via the S-hooks 8, and fastening the hook retaining portions 3c of the lower portion to the runner members 6c of the lower curtain rail 6 via the S-hooks 8, as shown in FIGS. 4A and 4B. The space inside of the curtain member 3 that is supported so as to be in a generally cylindrical shape is the booth interior 1a. In order to secure differential pressure between the booth interior 1a and the processing room 10, it is preferable to minimize the gap between the curtain member 3 and the curtain rails 5 and 6.

Also, as shown in FIG. 3A, openings 2a are formed in the top panel 2 of the isolation booth 1, and at these openings 2a, fan filter units (hereinafter referred to as “FFU”) 4 are provided for blowing clean air into the booth interior 1a, as shown in FIGS. 1A, 1B, and 2A. Each FFU 4 is an apparatus that includes a high performance filter (high efficiency particulate air (HEPA) filter) and that is able to supply clean air by taking in air from the processing room 10 and passing that air through the high performance filter.

Therefore, the isolation booth 1 is configured to increase the degree of cleanliness of the booth interior 1a by operating the FFUs 4 and delivering clean air into the booth interior 1a, and is configured to maintain the cleanliness of the booth interior 1a by preventing dust and the like in the processing room 10 from getting into the booth interior 1a, which is accomplished by keeping the pressure in the booth interior 1a a positive pressure with respect to the pressure in the processing room 10.

As shown in FIGS. 1A, 1B, and 2A, openings 3a are formed in predetermined positions of the curtain member 3. The “predetermined positions” in this case may be determined as appropriate according to the arrangement of the operating portion of the manufacturing equipment 20 and the like.

As shown in FIG. 2B, a glove member 7 that is a member that bulges out toward the inside of the booth interior 1a and block the openings 3a is formed at each of the openings 3a. The glove members 7 are members that are generally glove shaped (i.e., shaped so as to enable a worker to insert his or her hands and arms into them), and are provided to enable a worker to operate the manufacturing equipment 20 that is arranged in the booth interior 1a, while the worker is outside the booth interior 1a (i.e., is in the processing room 10). The glove members 7 are provided in the curtain member 3 in accordance with the operating portions of the manufacturing equipment 20 that is arranged in the booth interior 1a. In this example embodiment, the openings 3a are formed in the curtain member 3, and separate glove members 7 are provided so as to close the openings 3a. However, the glove members 7 may also be integrally formed with the curtain member 3.

As shown in FIG. 2A, the curtain member 3 is able to slide in the lateral direction along the curtain rails 5 and 6. Therefore, in the isolation booth 1, it is possible to change the position of the glove members 7 by sliding the curtain member 3 in the lateral direction along the curtain rails 5 and 6. Thus, it is possible to arrange the glove members 7 in any suitable position around the manufacturing equipment 20. By arranging the glove members 7 in a position at which it is necessary to operate the manufacturing equipment 20, for example, a worker is able to easily operate the manufacturing equipment 20 without having to change into clean room wear or pass through an air shower.

Also, the position of the glove members 7 with respect to the manufacturing equipment 20 can be easily changed by the worker moving (walking) around (i.e., circling) the isolation booth 1 while sliding the curtain member 3 along the curtain rails 5 and 6, while the hands and arms of the worker are inserted into the glove members 7, so even if there are a plurality of operating locations on the manufacturing equipment 20, the position of the glove members 7 with respect to the manufacturing equipment 20 can easily be changed so the operations can easily be performed.

In this way, the isolation booth 1 according to the first example embodiment of the invention enables a worker to operate and perform maintenance and the like on the manufacturing equipment 20 that is arranged in the clean booth interior 1a while remaining in the atmosphere of the processing room 10, without having to change into clean room wear or pass through an air shower.

In this example embodiment, the curtain member 3 is supported from above and below by the pair of upper and lower curtain rails 5 and 6. However, even with a configuration in which the curtain member 3 is supported by only the upper curtain rail 5, for example, the glove members 7 can still be moved by sliding the curtain member 3 in the lateral direction along the upper curtain rail 5. Therefore, even with an isolation booth in which the lower curtain rail 6 is omitted, for example, it is still possible to obtain the effect of a worker being able to operate and perform maintenance and the like on the manufacturing equipment arranged in the clean booth interior while remaining in the environment of the processing room, without having to change into clean room wear or pass through an air shower. However, in order to more reliably isolate the booth interior 1a, it is preferable to reliably support the curtain member 3 with the pair of upper and lower curtain rails 5 and 6. Also, it is preferable to support the curtain member 3 by the pair of upper and lower curtain rails 5 and 6 also to slide the curtain member 3 more smoothly.

That is, the isolation booth 1 according to the first example embodiment of the invention is designed to create the booth interior 1a that is a localized isolated space. The side surface of the booth interior 1a is screened by the curtain member 3 that is formed in an endless belt shape and has a ring shape when viewed from above, and the glove members 7 that bulge out toward the inside of the booth interior 1a are provided in the curtain member 3. Moreover, the curtain member 3 is supported by the curtain rails 5 and 6 that are ring shaped when viewed from above, and the curtain member 3 and the glove members 7 are able to be moved along the curtain rails 5 and 6. With this kind of structure, the glove members 7 can be moved along the curtain rails 5 and 6, so each portion of the manufacturing equipment 20 in the booth interior 1a can be operated from various angles.

Also, in the isolation booth 1 according to the first example embodiment of the invention, the curtain rail includes the upper curtain rail 5 that has a ring shape when viewed from above, and the lower curtain rail 6 that has the same ring shape as the upper curtain rail 5 when viewed from above. The upper curtain rail 5 and the lower curtain rail 6 are arranged so as to coincide with each other when viewed from above and parallel to each other when viewed from the side. The curtain member 3 is supported by these curtain rails 5 and 6. This kind of structure enables the glove members 7 to move more easily along the curtain rails 5 and 6. Thus, workability for workers can be improved.

While, in this example embodiment, the isolation booth 1 (i.e., a clean booth) that is used for increasing the degree of cleanliness of the booth interior 1a compared to the degree of cleanliness of the processing room 10 is described by way of example, the use of the isolation booth according to the invention is not limited to this. For example, the isolation booth may also be used to secure temperature and relative humidity conditions, or to prevent atmosphere dispersion.

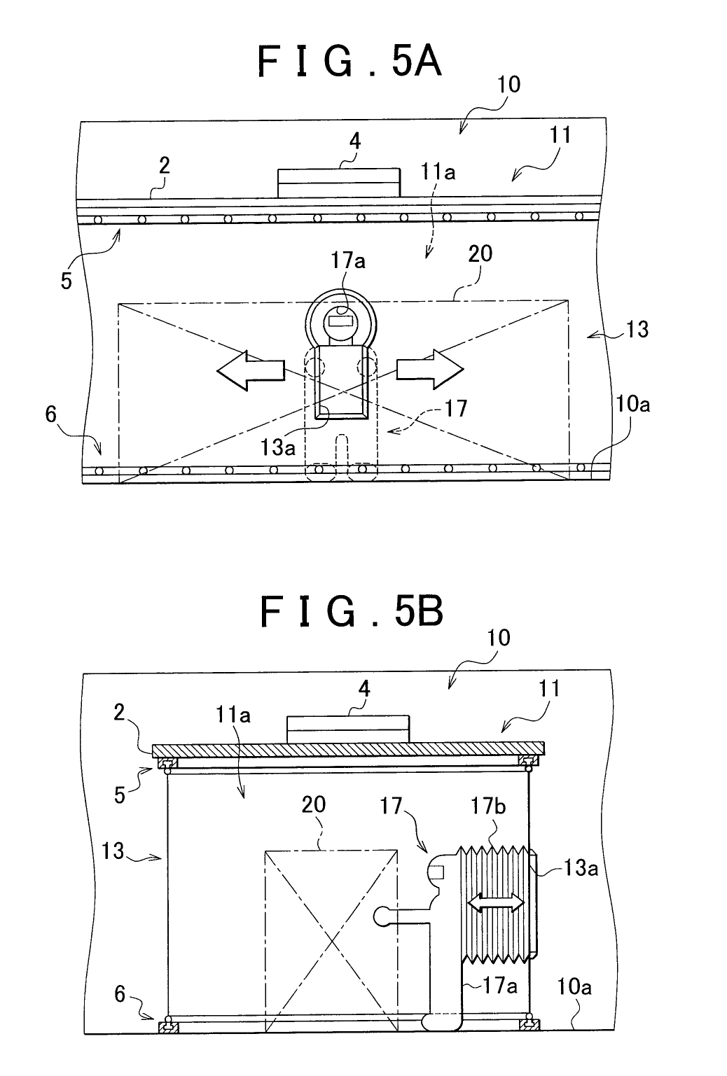

Next, an overall structure of an isolation booth according to a second example embodiment of the invention will be described with reference to FIGS. 5A and 5B.

An isolation booth 11 that is the isolation booth according to the second example embodiment of the invention shown in FIGS. 5A and 5B is an apparatus (what is called “clean booth”) for increasing the degree of cleanliness of the space inside of it (hereinafter referred to as the “booth interior 11a”) as compared to the degree of cleanliness outside of the space. In this example embodiment, the isolation booth 11 is arranged so as to surround manufacturing equipment 20 that is arranged in a processing room 10. The isolation booth 11 creates a space (i.e., the booth interior 11a) around the manufacturing equipment 20 where a higher degree of cleanliness than that of the processing room 10 is secured.

As shown in FIGS. 5A and 5B, the isolation booth 11 is structured such that a curtain member 13 extends between curtain rails 5 and 6, and a vertical surface (i.e., a side surface) between a top panel 2 and a floor 10a is covered in an airtight manner by the curtain member 13. An opening 13a is formed at a predetermined position in the curtain member 13. This opening 13a is sealed by a glove member 17 that is able to accommodate not only the hands and arms of a worker, but also the head, torso, and legs, etc. (i.e., the entire body) of the worker.

The glove member 17 is provided so that a worker can operate the manufacturing equipment 20 arranged in the booth interior 11a while being in the atmosphere outside the isolation booth 11 (i.e., in the processing room 10). This glove member 17 includes a suit portion 17a that has a shape corresponding to the shape of a human body (the entire body), and a bellows-shaped expanding and contracting portion 17b that connects the suit portion 17a to the curtain member 13. A transparent window portion or the like for viewing, or seeing the booth interior 11a is also provided in the suit portion 17a at a portion thereof that covers the head of a worker.

That is, the isolation booth 11 differs from the isolation booth 1 in that it has the curtain member 13 that is different from the curtain member 3. In addition, the isolation booth 11 differs from the isolation booth 1 in that it has the glove member 17 that is different from the glove members 7, at the opening 13a formed in the curtain member 13. The structure of the isolation booth 11 other than the curtain member 13 and the glove member 17 is the same as that of the isolation booth 1.

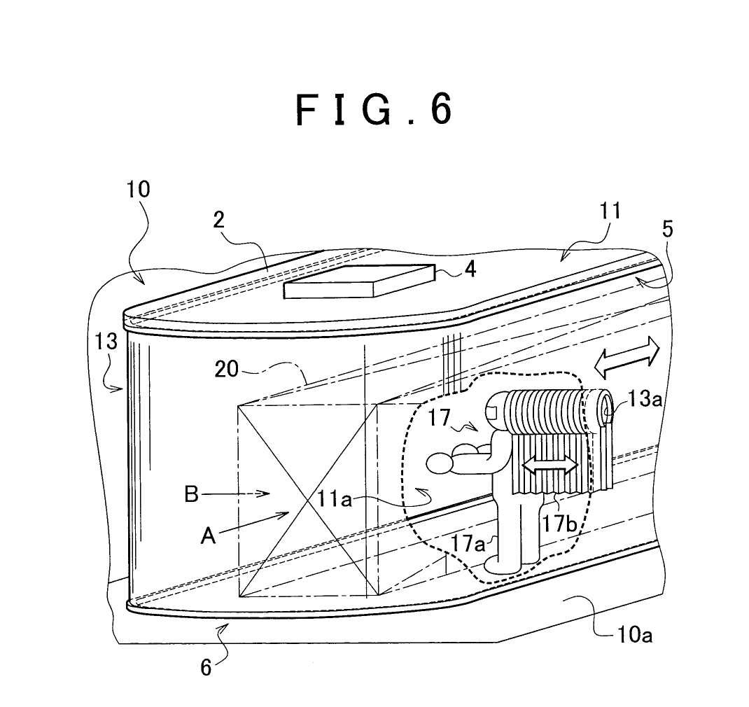

As shown in FIGS. 5A, 5B, and 6, the curtain member 13 is able to slide in the lateral direction along the curtain rails 5 and 6 as in the case of the curtain member 3, so the position of the glove member 17 can be changed by sliding the curtain member 13 in the lateral direction along the curtain rails 5 and 6.

A worker is able to stand on the floor 10a of the booth interior 11a while being in the atmosphere of the processing room 10 by putting his or her entire body into the suit portion 17a, and drag the curtain member 13 around by walking around, or circling the manufacturing equipment 20. The worker is also able to move around in the booth interior 11a within the range that the curtain member 13 can slide and the expanding and contracting portion 17b can expand and contract. That is, the worker can operate or work on the manufacturing equipment 20 from the direction of arrow A in FIG. 6, or can operate or work on the manufacturing equipment 20 from the direction of arrow B, for example.

Therefore, when the isolation booth 11 having the glove member 17 is used, maintenance can be performed even closer to the manufacturing equipment 20 than when the isolation booth 1 having the glove members 7 is used. In addition, the degree of freedom in the working posture of a worker increases, so operating or working on (e.g., performing maintenance on) the manufacturing equipment 20 can be done while checking details.

That is, using the isolation booth 11 according to the second example embodiment of the invention makes it possible to ensure the same level of workability as that realized when operation, maintenance, or the like of the manufacturing equipment 20 is performed after a worker changes into clean room wear and enters the booth interior 11a, without a worker having to change into clean room wear or pass through an air shower. Therefore, operation and maintenance of the manufacturing equipment 20 can be performed more easily.

That is, with the isolation booth 11 according to the second example embodiment of the invention, the suit portion 17a of the glove member 17 has a shape corresponding to the shape of the entire body of a person (a worker). This structure makes it possible for a worker to operate the manufacturing equipment 20 in the booth interior 11a without having to change into clean room wear or pass through an air shower.

In addition, in the isolation booth 11 according to the second example embodiment of the invention, the suit portion 17a of the glove member 17 is connected to the curtain member 13 via the expanding and contracting portion 17b that is an expanding and contracting member. This kind of structure enables a worker to operate the manufacturing equipment 20 in the isolation booth 11 more freely.

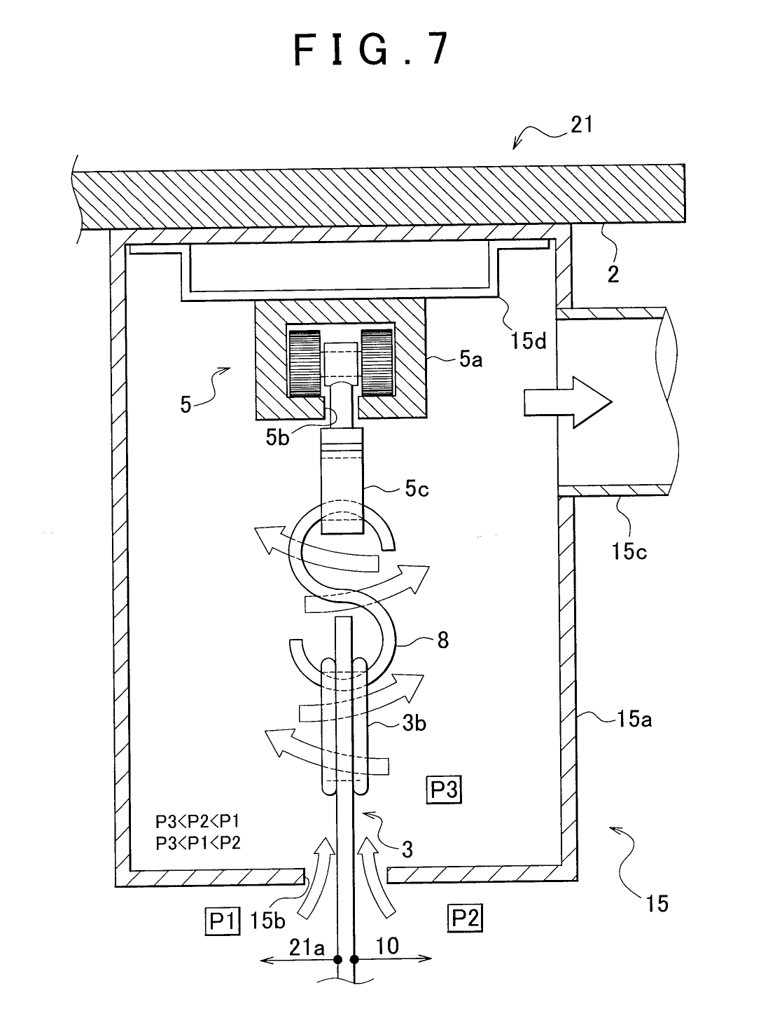

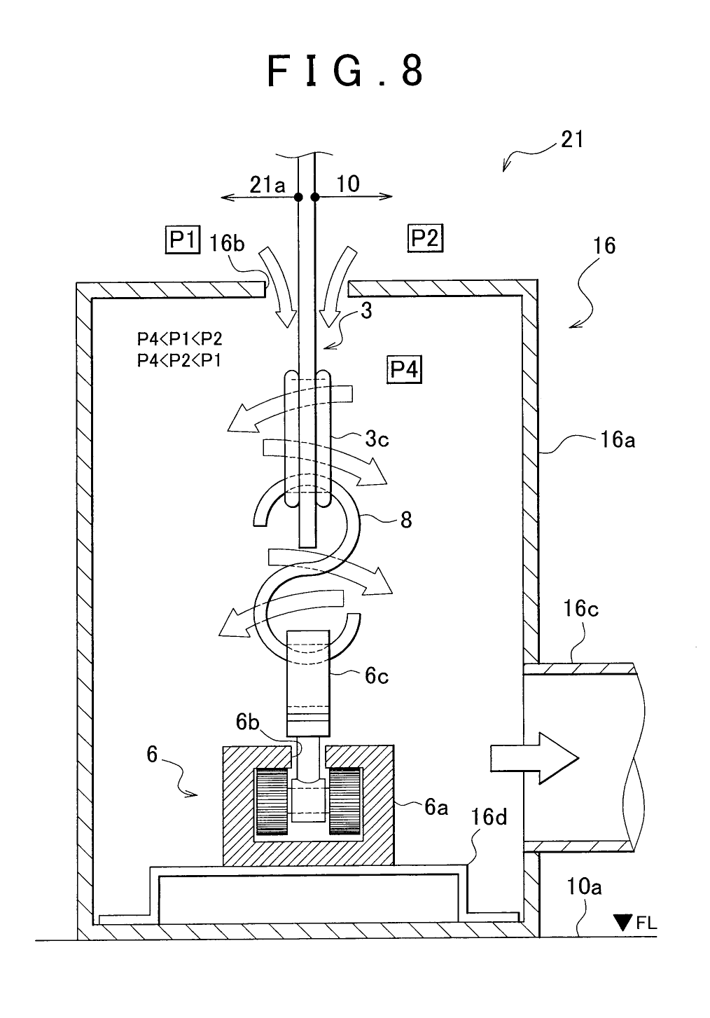

Next, an isolation booth according to a third example embodiment of the invention will be described with reference to FIGS. 7 and 8. The isolation booth 21 according to the third example embodiment of the invention is configured such that the upper curtain rail 5 is covered by an upper curtain box 15, as shown in FIG. 7, while the lower curtain rail 6 is covered by a lower curtain box 16, as shown in FIG. 8.

Also, the upper curtain box 15 has a box portion 15a that is a portion that covers the upper curtain rail 5, and an opening 15b that is a portion for taking in air from a booth interior 21a and the processing room 10, as shown in FIG. 7. Moreover, a duct 15c for discharging air from inside the box portion 15a is connected to the box portion 15a.

Similarly, the lower curtain box 16 has a box portion 16a that is a portion that covers the lower curtain rail 6, and an opening 16b that is a portion for taking in air from the booth interior 21a and the processing room 10, as shown in FIG. 8. Moreover, a duct 16c for discharging air from inside the box portion 16a is connected to the box portion 16a.

For example, if a pressure P1 in the booth interior 21a is lower than a pressure P2 in the processing room 10, there is a possibility that the air in the processing room 10 may flow into the booth interior 21a through a gap or the like at a peripheral portion of the curtain member 3, so the degree of cleanliness in the booth interior 21a may not be able to be secured.

Therefore, in the isolation booth 21 according to the third example embodiment of the invention, if the pressure P1 in the booth interior 21a is lower than the pressure P2 in the processing room 10, air is discharged through the duct 15c in the upper curtain box 15 so that a pressure P3 inside the box portion 15a becomes lower than the pressure P1 (i.e., P3<P1<P2). At the same time, in the lower curtain box 16 as well, air is discharged through the duct 16c so that a pressure P4 inside the box portion 16a becomes lower than the pressure P1 (i.e., P4<P1<P2).

Further, if the pressure P1 in the booth interior 21a is greater than the pressure P2 in the processing room 10, for example, there is a possibility that air in the booth interior 21a may flow out into the processing room 10 through a gap or the like in the peripheral portion of the curtain member 3. However, there are cases in which it is not desirable for the atmosphere in the booth interior 21a to flow out to the outside (such as when the atmosphere contains organic solvent, for example).

In such cases, in the isolation booth 21, air is discharged through the duct 15c in the upper curtain box 15 so that the pressure P3 in the box portion 15a will become lower than the pressure P2 (i.e., P3<P2<P1). Also, at the same time, in the lower curtain box 16 as well, air is discharged through the duct 16c so that the pressure P4 in the box portion 16a becomes lower than the pressure P2 (i.e., P4<P2<P1).

As a result, in the curtain boxes 15 and 16, the air from the booth interior 21a and the air from the processing room 10 are mixed. However, this mixed air is discharged through the ducts 15c and 16c without leaking out into the booth interior 21a or the processing room 10, so the booth interior 21a is isolated from the processing room 10. In addition, the booth interior 21a is reliably isolated from the processing room 10 by adjusting the amount of air discharged from the ducts 15c and 16c according to the usage conditions of the manufacturing equipment 20 and the isolation booth 21.

In this way, with the isolation booth 21 according to the third example embodiment of the invention, air (i.e., the atmosphere) in the booth interior 21a and the processing room 10 can be reliably prevented from going back and forth through the support portions (i.e., the gaps of the S-hooks 8, the hook retaining portions 3b, the hook retaining portions 3c, and the like), at which the curtain member 3 is supported using the curtain rails 5 and 6, by employing a configuration, in which the curtain rails 5 and 6 are covered by the curtain boxes 15 and 16 and the air inside of the curtain boxes 15 and 16 is discharged. As a result, the booth interior 21a is reliably isolated from the processing room 10.

That is, the isolation booth 21 according to the third example embodiment of the invention includes the curtain boxes 15 and 16 that are sealing devices for preventing air from flowing into the booth interior 21a from the processing room 10 through gaps between the curtain rails 5 and 6 and the curtain member 3 (i.e., the gaps of the S-hooks 8, the hook retaining portions 3b, the hook retaining portions 3c, and the like) and preventing air from flowing out of the booth interior 21a into the processing room 10 through the gaps. With this kind of structure, the booth interior 21a is more reliably isolated.

The invention has been described with reference to example embodiments for illustrative purposes only. It should be understood that the description is not intended to be exhaustive or to limit form of the invention and that the invention may be adapted for use in other systems and applications. The scope of the invention embraces various modifications and equivalent arrangements that may be conceived by one skilled in the art.

The curtain rail may include an upper curtain rail that is provided on the top portion and that has a ring shape when viewed from above and a lower curtain rail that is provided on the bottom portion and that has the same ring shape as the upper curtain rail when viewed from above; the upper curtain rail and the lower curtain rail may be arranged so as to substantially coincide with each other when viewed from above and be parallel to each other when viewed from the side; and the curtain member may be supported by the upper curtain rail and the lower curtain rail in a manner so as to be able to be moved along the upper curtain rail and the lower curtain rail. This enables a glove member to move more easily along the curtain rails, thereby further improving workability for a worker.

The glove member may have a shape corresponding to the shape of the entire body of a person. This enables a worker to operate manufacturing equipment that is inside of the isolation booth without having to change into clean room wear or pass through an air shower.

The glove member may be connected to the curtain member via the expanding and contracting member. This enables a worker to operate manufacturing equipment that is inside of the isolation booth more freely.

The sealing device for preventing air from flowing into the space from outside through a gap between the curtain rail and the curtain member and preventing air from flowing out from the locally isolated space to the outside through the gap may be provided. As a result, the inside of the isolation booth is able to be more reliably isolated.

What is claimed is:

1. An isolation booth for creating a locally isolated space, comprising:
a top portion;
a bottom portion;
a curtain rail that is provided on at least one of the top portion and the bottom portion; and
a curtain member that is in an endless belt shape and has a ring shape when viewed from above, is supported by the curtain rail in a manner so as to be able to be moved along the curtain rail, and is provided so as to create the space between the top portion and the bottom portion, the curtain member including a glove member that bulges out toward an inside of the space.

2. The isolation booth according to claim 1, wherein:
the curtain rail includes an upper curtain rail that is provided on the top portion and that has a ring shape when viewed from above and a lower curtain rail that is provided on the bottom portion and that has the same ring shape as the upper curtain rail when viewed from above;
the upper curtain rail and the lower curtain rail are arranged so as to substantially coincide with each other when viewed from above and be parallel to each other when viewed from a side; and
the curtain member is supported by the upper curtain rail and the lower curtain rail in a manner so as to be able to be moved along the upper curtain rail and the lower curtain rail.

3. The isolation booth according to claim 1, wherein
the glove member has a shape corresponding to a shape of a whole human body.

4. The isolation booth according to claim 3, wherein
the glove member is connected to the curtain member via an expanding and contracting member.

5. The isolation booth according to claim 1, further comprising a sealing device for preventing gas from flowing into the space from outside through a gap between the curtain rail and the curtain member and preventing gas from flowing out of the space to the outside through the gap.

6. The isolation booth according to claim 5, wherein
the sealing device includes a box portion that covers the curtain rail and the gap, and a duct for discharging gas from the box portion, and
the box portion has an opening, through which the curtain member is passed, and that is partitioned into a first opening and a second opening by the curtain member, wherein an inside of the box portion communicates with the space inside of the curtain member through the first opening and communicates with the outside through the second opening.

7. The isolation booth according to claim 1, further comprising
a gas supplying device for supplying gas to the space inside of the curtain member.

8. The isolation booth according to claim 7, wherein
the gas supplying device includes a gas supply opening portion that has a filter and is provided in the top portion.

9. An isolation booth for creating a locally isolated space, comprising
a curtain member for isolating the locally isolated space, the curtain member being formed in an endless belt shape and has a ring shape when viewed from above, wherein:
the curtain member includes a glove member that bulges out toward an inside of the locally isolated space;
the curtain member is supported by a curtain rail that has a ring shape when viewed from above; and
the curtain member and the glove member are configured to be able to be moved along the curtain rail.

10. The isolation booth according to claim 9, wherein:
the curtain rail includes an upper curtain rail that has a ring shape when viewed from above and a lower curtain rail that has the same ring shape as the upper curtain rail when viewed from above;
the upper curtain rail and the lower curtain rail are arranged so as to substantially coincide with each other when viewed from above and be parallel to each other when viewed from a side; and
the curtain member is supported by the upper curtain rail and the lower curtain rail.
